(19) United States
(12) Patent Application Publication
(10) Pub. No.: US 2008/0046841 A1
(43) Pub. Date: Feb. 21, 2008

(54) Drop dialog controls

(75) Inventor: Raymond J. Ridl, Fargo, ND (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/504,500

(22) Filed: Aug. 15, 2006

(51) Int. Cl. G06F 3/048

(52) U.S. Cl. 715/843

(57) ABSTRACT

A drop dialog window may be presented graphically coupled with a user interface control used to activate the drop dialog window. The drop dialog window may present one or more interactive controls allowing a user to select or enter data. The interactive controls may be both bound and unbound. The drop dialog window may allow multiple interactive controls to be activated to select or update more than one control per instantiation of the drop dialog window. The drop dialog window may be persistent until explicitly dismissed or until focus is removed from the drop dialog window. Acceptance of default values without presenting the drop dialog window may be accomplished by an alternate selection of the user interface control.

### BACKGROUND

Drop-down menus have been in use since the advent of windowed user interfaces. A drop-down menu conserves screen space by allowing available commands to be found and accessed in an orderly fashion. Drop-down menus are characterized by one or more levels of single-pick actions. That is, a list of options are presented and when one of the options is selected, the drop-down menu is dismissed and the selected action is initiated. Often, the next action following a drop-down menu selection is a pop-up dialog. Pop-up dialogs appear in separate windows and are free-standing. The pop-up dialogs are often placed away from the original menu pick. For example, placement may be based on the location relative to the total display area rather than the location of the original menu pick. Such placement can make the pop-up hard to locate, especially when using multiple monitor configurations. In addition, display-relative pop-up dialogs may require traversing considerable distances to reach the pop-up. In other cases, pop-up dialogs are simply placed at the current cursor position.

Pop-up dialogs are often used when multiple data entries are required, such as form data entry, although some pop-up dialogs are simply used for confirmation. For example, “Are you sure you want to quit? Yes/No” The user may have a choice of traversing the cursor or taking a hand off the mouse control and moving to the keyboard to press the ‘Enter’ key. Particularly in large screen environments, when a lot of windows are open, or when multiple displays are used, the pop-up dialogs may be difficult to locate and navigation to the pop-up dialog may be a nuisance.

### SUMMARY

A graphical element called a drop dialog allows developers to attach forms, data entry controls, and confirmation requests to a user interface element, such as a button. The drop dialog may be graphically attached to the user interface element to make it easy to identify and to shorten the cursor traverse to reach the drop dialog. The drop dialog is maintained as long as focus is kept in the drop dialog window or the drop dialog is explicitly dismissed, allowing multiple controls to be accessed in one instantiation. Data entry controls may be bounded, that is, data may be selected from a fixed set, but unbounded controls may be supported as well. The drop dialog may be dismissed by removing focus, e.g. clicking on another window, or explicitly dismissed by pressing an ‘OK’ or ‘cancel’ button.

### BRIEF DESCRIPTION OF THE DRAWINGS

FIG. 1 is a block diagram of a computer;

FIG. 2 is a block diagram of a representative memory, such as one found in the computer of FIG. 1;

FIG. 3 is a method of implementing a user interface for managing a drop dialog;

FIG. 4 is a method of implementing a drop dialog window;

FIG. 5 is a simplified and representative illustration of a user interface screen;

FIG. 6 is a simplified and representative illustration of a drop dialog window; and

FIG. 7 is another simplified and representative illustration of a drop dialog window.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

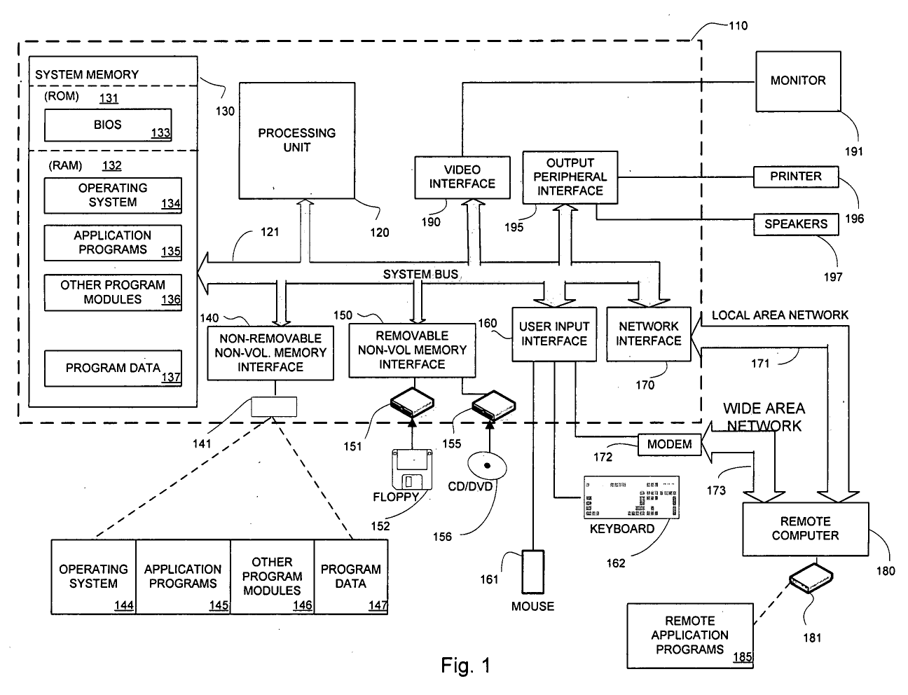

FIG. 1 illustrates a computing device in the form of a computer 110 that may host one or more of the embodiments of the current disclosure. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means, a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Another input device may be a camera for sending images over the Internet, known as a web cam 163. Other input devices (not shown) may include a microphone, joystick, game pad, satellite dish, scanner, or the like. These and other input devices are often connected to the processing unit 120 through a user input interface 160 that is coupled to the system-bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

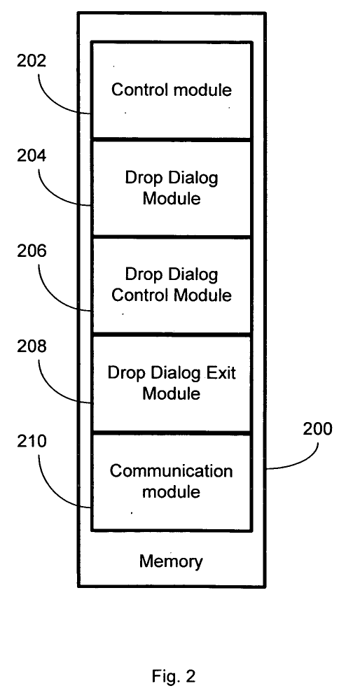

FIG. 2, a block diagram of a representative memory, is discussed and described. The memory 200 may be any processor accessible memory, such as system memory 130, non-removable memory 141, or removable memory 151, shown in FIG. 1. The memory 200 1may store executable instructions such as a control module 202, a drop dialog module 204, a drop dialog control module 206, a drop dialog exit module 208, and a communication module 210.

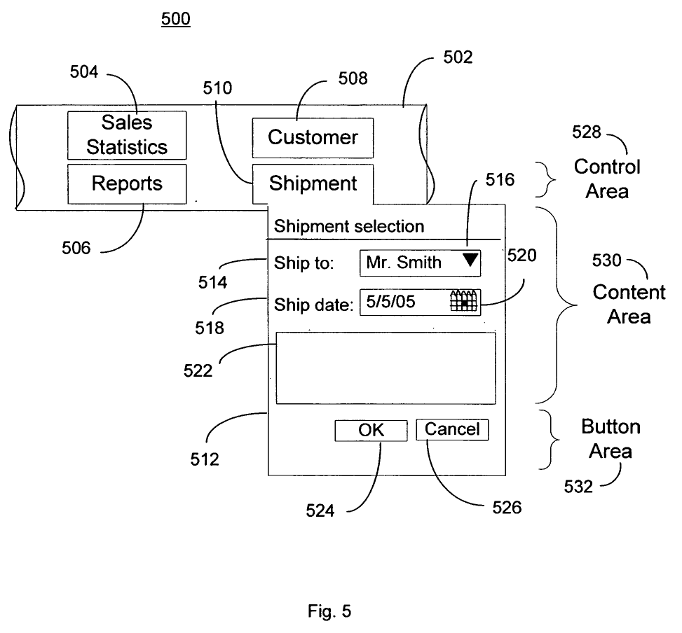

The control module 202 may be a control suitable for managing a user interface, or a user interface element, such as a menu bar, button controls, or other known UI elements. Exemplary user-interface elements are discussed in more detail in FIGS. 5-7. The control module 202 may present the user with available selections, for example, for managing a workflow process such as data entry, order capture, or order processing. The control module 202 may be activated by a user selection or may be triggered by another related event. For example, an order processing event may cause a window to be displayed having one or more UI elements with associated control modules such as control module 202.

When the UI element is activated, control module 202 may cause execution of the drop dialog module 204. The drop dialog module may paint a window that is physically attached to its associated UI element. The drop dialog module 204 may in turn have one or more drop dialog control modules 206 presenting respective drop dialog UI elements. Specifically, a drop dialog exit module 208 may be activated to display an explicit UI element for dismissing the drop dialog window, such as an “OK” or “Cancel” button. A communication module 210 may allow messages to be received from another process or the operating system that would indicate that focus has been moved to another window, which would also dismissed the drop dialog window.

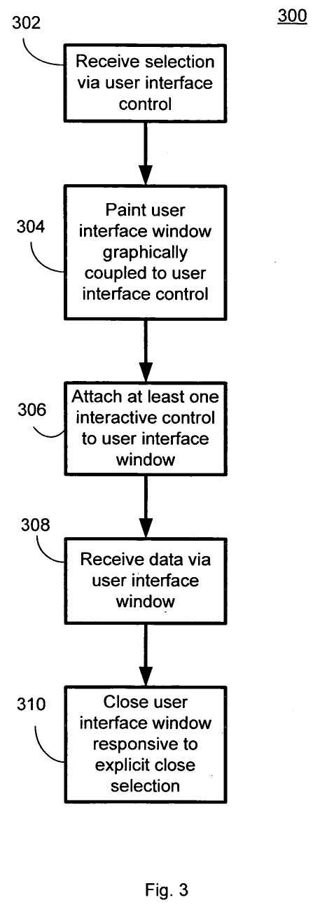

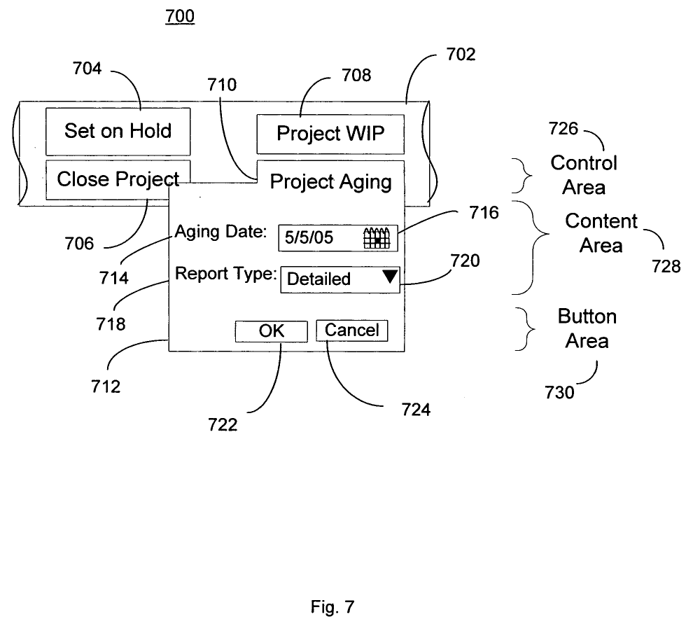

FIG. 3 illustrates a method 300 of implementing a user interface for managing a drop dialog. At block 302, a user selection may be received via a user interface control, such as a menu selection. In one embodiment, the menu selection may be a menu button. At block 304, a user interface window (drop dialog) may be painted such that it is graphically coupled to the user interface control used for the selection at block 302. Graphically coupling the user interface window to a user interface control may include placing the user interface window such that it is physically touching the original control, for example, the menu button, and may use a common look and feel such as shading and font type. FIG. 5 and FIG. 7 have representative examples including graphical coupling.

At block 306, one or more interactive controls may be attached to the user interface window for presenting prompts and data collection elements. As discussed above, a bounded control may be used in some embodiments, but unbounded controls may also be configured and used. At block 308, data may be received via the one or more interactive controls. Unlike a known toolbar menu pick, the interactive controls may be updated, changed, or used consecutively without dismissing the user interface window. At block 310, the user interface window may be closed responsive to an explicit close selection, or by removing focus from the user interface window, effectively canceling any data captured from being input.

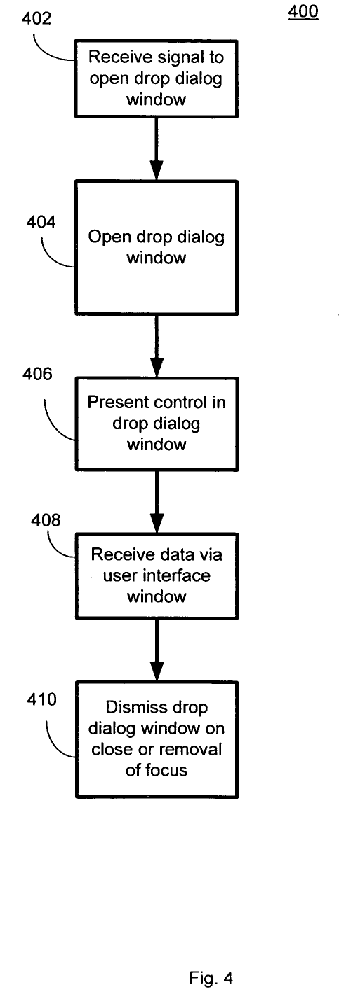

FIG. 4 illustrates a method 400 of using a drop dialog window. At block 402, a signal may be received to open a drop dialog window. At block 404, the drop dialog window may be presented. In an exemplary embodiment, the drop dialog window may be graphically attached to the control which initiated the signal in block 402. At block 406, controls may be attached to the drop dialog window for use by a user in selecting or inputting data. At block 408, the data received via the user interface may be collected for presentation to a receiving program or module. At block 410, the drop dialog may be dismissed on receipt of an explicit close action or by removal of focus from the drop dialog window.

In an alternate embodiment, the signal received at block 402 may indicate that default values should be forwarded to the receiving program or module and the drop dialog window should not be presented, in which case, no visible graphics activity takes place. For example, rather than clicking on a menu button to open a drop dialog window, a power user may CTRL-click the menu button to accept known default entries and proceed.

FIG. 5 is a simplified and representative illustration of a portion of a user interface 500, such as may be found on a computer monitor 191 of FIG. 1 or the display of an other electronic device. The portion of the user interface 500 illustrated includes, in this example, a menu bar 502 and a plurality of menu buttons 504 506 508 510. In other embodiments, the user interface element involved may be any interactive portion of the user interface, including toolbars, ribbons, or standard buttons on window forms. Each button represents a different function available for user selection and may correspond to the user interface control active in block 302 of FIG. 3. The menu button 510, associated with shipment, is shown having been selected and a drop dialog window 512 painted as graphically coupled to the button 510. A “ship to” prompt 514 may be associated with a combo-box control 516 allowing selection from a predetermined list of customers, as shown in this exemplary embodiment. A “ship date” prompt 518 may be associated with a date selection control 520, allowing input restricted to dates. The combo-box 516 and date selection control 520 illustrate bounded controls, that is, controls that restrict input to a given set. A text control 522 illustrates an unbounded control where free-form text entry may be made. “OK” and “Cancel” buttons, 524 and 526 respectively, may be used to dismiss the drop dialog window 512 at either the completion of data entry or to cancel without processing drop dialog window data.

The drop dialog window 512 may be divided into three general sections as illustrated, a control area 528, that is, the control by which the drop dialog is activated and attached to, a content area 530 for presentation of the title and data entry controls, and a button area 532 for presentation of dismissal buttons 524 526.

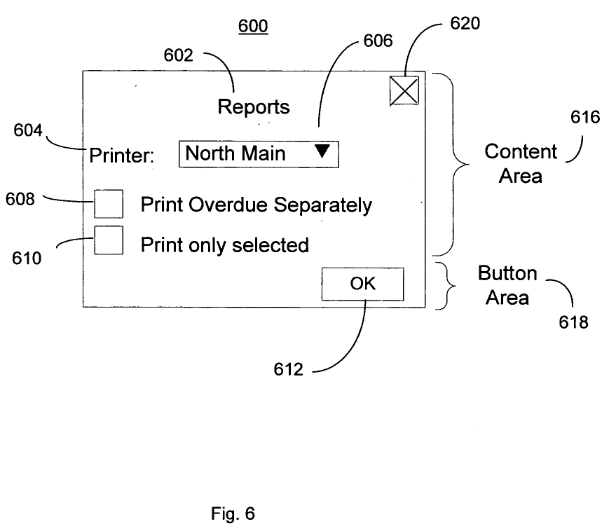

FIG. 6 illustrates a drop dialog window 600 apart from its associated user interface control (control area). The drop dialog window 600 has a title 602, and a prompt 604 associated with a combo-box 606. Checkboxes 608 and 610 may be activated separately according to the user's requirements. An “OK” box 612 may be used to dismiss the drop dialog window 600. Because no explicit cancel button is present, in one embodiment, canceling is accomplished by simply removing focus from the drop dialog window 600 by clicking in another area of the display (not depicted). As in the exemplary embodiment of FIG. 5, the drop dialog window 600 has a content area 616 and a button area 618. In some embodiments, the drop dialog may be dismissed by selecting a familiar close icon 620 or other non-textual image.

FIG. 7 illustrates another example of a drop dialog window. A portion of a user interface screen 700 is presented showing a menu bar 702 and a variety of control buttons 704 706 708 and 710. The control button 710, representing project aging, is shown having been selected and an associated drop dialog window 712 is shown graphically coupled to the project aging button 710. A “date” prompt 714 is associated with a date selection control 716. A “type” prompt 718 is associated with a combo-box 720. An “OK” button 722 and a “Cancel” button 724 may be used to accept or dismiss the data in the drop dialog window 712 as discussed above. Additionally, removing focus from the drop dialog window 712 may have the same affect as pressing the “Cancel” button 724. As in previous examples, the drop 317338.01 dialog window 712 is shown having a control area 726, a content area 728, and a button area 730.

The use of drop dialogs presents users with a simple and convenient method of user interface interaction by presenting users with easy to locate and operate data entry and selection opportunities. By coupling a drop dialog window with the control that activates it and by allowing multiple data entry activities to occur before dismissal of the drop dialog window a simpler and more streamlined capability is offered to users. The ability to accept default entries using an alternative selection method further facilitates timely and accurate data entry.

Although the forgoing text sets forth a detailed description of numerous different embodiments of the invention, it should be understood that the scope of the invention is defined by the words of the claims set forth at the end of this patent. The detailed description is to be construed as-exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations maybe made in the techniques and structures described and illustrated herein without departing from the spirit and scope of the present invention. Accordingly, it should be understood that the methods and apparatus described herein are illustrative only and are not limiting upon the scope of the invention.

We claim:

1. A computer-readable medium having computer-executable instructions implementing a method comprising:
receiving a selection via a user interface control;
painting a user interface window so that the user interface window is graphically coupled to the user interface control;
attaching at least one interactive control to the user interface window;
receiving data via the user interface window; and
closing the user interface window when an explicit close function is selected.

2. The computer-readable-medium of claim 1, wherein the user interface control is a push button.

3. The computer-readable medium of claim 1, wherein receiving a selection from a user interface control comprises receiving an alternate selection from the user interface control that causes a pre-determined data to be entered and the user interface window is not painted.

4. The computer-readable medium of claim 1, wherein the user interface window remains while focus is in the user interface window.

5. The computer-readable medium of claim 1, wherein painting a user interface window comprises painting a user interface window with a control area, a content area, and a button area.

6. The computer-readable medium of claim 1, further comprising attaching on the user interface window one of a dismiss and accept button comprising the explicit close function.

7. The computer-readable medium of claim 1, wherein the explicit close function is represented by a non-textual image.

8. The computer-readable medium of claim 1, wherein attaching at least one interactive control to the user interface window comprises attaching only bounded data containers to the user interface window.

9. The computer-readable medium of claim 1, further comprising painting a user interface window further comprises activating code associated with the user interface control for painting the user interface window.

10. The computer-readable medium of claim 1, further comprising attaching a second interactive control to the at least one interactive control.

11. A method of presenting a user interface interaction comprising:
opening a drop dialog window coupled to a user interface element;
presenting at least one control in the drop dialog window; and
dismissing the drop dialog window when one of an explicit close function is selected and when focus is removed from the drop dialog window.

12. The method of claim 11, further comprising receiving a signal for triggering the opening of the drop dialog window.

13. The method of claim 11, wherein opening the drop dialog window comprises opening the drop dialog window by activating code in the user interface element.

14. The method of claim 11, wherein presenting at least one control comprises presenting only bounded controls in the drop dialog window.

15. The method of claim 14, wherein opening the drop dialog window comprises painting a control area, a content area, and a button area, wherein the content area contains the bounded controls and the button area contains the explicit close function.

16. The method of claim 11, wherein the explicit close function is one of an accept button and a cancel button.

17. The method of claim 11, further comprising opening a second drop dialog window coupled to the drop dialog window responsive to input from the drop dialog window.

18. A computer for use with a data processing program comprising:
a processor;
a display coupled to the processor; and
a memory coupled to the processor containing executable modules comprising:
a control module that receives an activation signal from a user interface control;
a drop dialog module that paints a drop dialog window graphically attached to the user interface control responsive to the activation signal;
a drop dialog control module that receives user input and is attached to the drop dialog window; and
a drop dialog exit module that closes the drop dialog window when activated.

19. The computer of claim 18, further comprising a communication module that receives an operating system signal indicating focus has left the drop dialog window and activates the drop dialog exit module.

20. The computer of claim 18, wherein the drop dialog module enters predetermined data instead painting the drop dialog window responsive to an alternate activation signal received at the control module.
